(19) United States
(12) Patent Application Publication
(10) Pub. No.: US 2004/0027830 A1
(43) Pub. Date: Feb. 12, 2004

(54) Lampshade formed by a plurality of rings

(76) Inventor: Er-Shiang Chen, Taipei (TW)

Correspondence Address: Er-Shiang Chen, 235 Chung-ho, Box 8-24, Taipei, TW

(21) Appl. No.: 10/213,300

(22) Filed: Aug. 7, 2002

(51) Int. Cl. F21V 1/06; F21V 1/12

(52) U.S. Cl. 362/352; 362/360; 362/450

(57) ABSTRACT

A lampshade formed by a plurality of rings comprises an upper ring, a plurality of upper section unit rings, a middle ring, a plurality of lower section unit rings; and a lower ring, which are arranged sequentially from an upper end to an lower end. A plurality of hooked rings are extended from each of the upper section unit rings. The upper section unit rings are serially connected by using chains to pass through the hooked rings. Two ends of the chain are locked to the upper ring and the middle ring. The lower section unit rings are arranged with a way like that of the upper section unit ring. By above structure, the ring structure is foldable so that the rings are overlapped and thus the whole lampshade has a smaller volume so that it can be stored and transferred easily and conveniently.

### FIELD OF THE INVENTION

The present invention relates to lampshades, and particularly to a lampshade formed by a plurality of rings which are foldable so that all the ° rings are overlapped to reduced the volume thereof for transfer and storage conveniently and easily.

### BACKGROUND OF THE INVENTION

Conventionally, lampshade has a fixed structure. All the elements are fixed between a top ring and a lower ring. However, since the structure of the lampshade is fixed so that it occupies a larger volume. As the lampshade is transferred or stored, a large volume is required. Thereby, the costs in transfer and storage are not economic. Therefore, there is an eager demand for a novel design which can improve this prior art defect.

### SUMMARY OF THE INVENTION

Accordingly, the primary object of the present invention is to provide a lampshade formed by a plurality of rings comprising an upper ring, a plurality of upper section unit rings, a middle ring, a plurality of lower section unit rings; and a lower ring, which are arranged sequentially from an upper end to an lower end. Each upper section unit ring has a lower cross section. A plurality of hooked rings are extended from the lower cross section. The upper section unit rings are serially connected by using chains to pass through the hooked rings. Two ends of the chain are locked to the upper ring and the middle ring. The lower section unit rings are arranged with reduced diameters from the upper one to the lower one. A plurality of-hooked rings are extended from the upper cross section. The lower section unit rings are serially connected by using chains to pass through the hooked rings. Two ends of the chain are locked to the lower ring and the middle ring. By above structure, all the rings can be folded so that the rings are overlapped and thus the whole lampshade has a smaller volume so that it can be stored and transferred easily and conveniently.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 1A is a partial enlarged view of the FIG. 1.

FIG. 2 is an assembled perspective view of the present invention.

FIG. 2A is a partial enlarged view of FIG. 2.

### DETAILED DESCRIPTION OF THE PREFERRED EMBODIMENTS

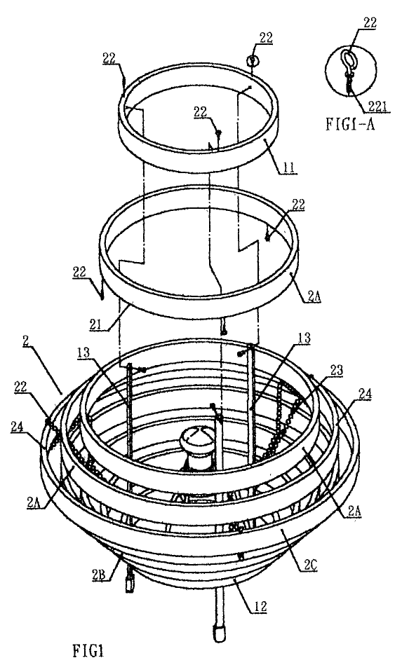

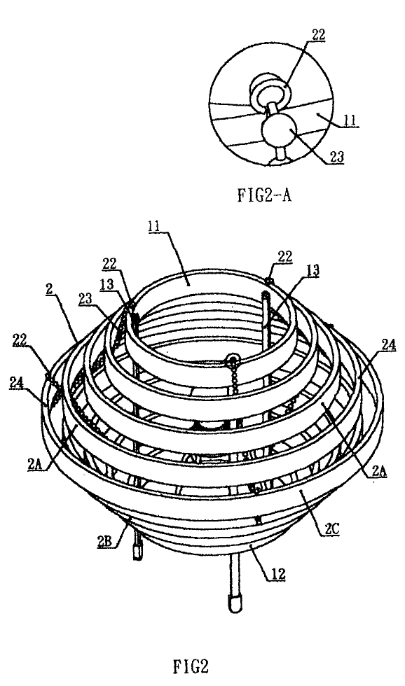

Referring to FIGS. 1, 1A, 2 and 2A, the structure of the present invention is clearly shown. The lampshade of the present invention is formed by a plurality of rings.

The lampshade is formed by a plurality of rings of different diameters. The arrangement of these rings are changeable as desired.

Referring to FIG. 2, the lampshade 2 is formed by a plurality of upper section unit rings 2A and a plurality of lower section unit rings 2B. The upper section unit rings 2A are arranged below the upper ring 11. The lower section unit rings 2B are arranged above the lower ring 12. A middle ring 2C is installed between the upper section unit rings 2A and the lower section unit rings 2B for connecting the two.

A plurality of support rods 13 are upwards extended through the edge of the lower ring 12. A top of each support rod 13 is firmly secured to an upper ring 11. A bulb is installed in the lampshade 2.

The plurality of upper section unit rings 2A are arranged with the rings at the lower side of the upper section unit rings 2A having large diameters. Each upper section unit ring 2A has a lower cross section 21. A plurality of hooked rings 22 (referring to FIG. 1A) are extended from the lower cross section 21. One end of the hooked ring 22 is a tapered threaded section 221 and another end thereof is a round hook (referring to FIG. 1A). The threaded section 221 is locked into the lower cross section 21 of an adjacent upper section unit ring 2A. A chain 23 passes through the round hook and then the chain 23 passes through another round hook of the hooked ring 22 of an adjacent upper section unit ring 2A (referring to FIG. 2A). The distal end of the chain 23 is locked to a hooked ring 22 of the upper ring 1-1. Thereby, the upper section unit rings 2A are suspended from the upper ring 11.

The lower section unit rings 2B are arranged with reduced diameters from the upper one to the lower one. Each lower section unit-ring 2B has an upper cross section 24. A plurality of hooked rings 22 are extended from the upper cross section 24. A chain 23 passes through the hooked ring of the lower section unit ring 2B and then through the hooked ring of an adjacent lower section unit ring 2B. Finally, the chain 23 is ended at the lower ring 12. Thereby, the lower section unit rings are serially connected to the lower ring 12.

The hooked rings 22 of the upper section unit ring 2A and the lower section unit ring 2B are locked to the middle ring 2C. All the chains 23 have one ends locked to the middle ring 2C.

However, the arrangements of the rings 11, 2A, 2C, 2B and 12 can be changed. For example, the ring 2C has a smallest diameter. The diameters of all the rings are increased with the distance away from the middle ring 2C. Other-wise, the other structure are the same as that described above.

Moreover, by above structure, all the rings can be folded so that the rings are overlapped and thus the whole lampshade has a smaller volume so that it can be stored and transferred easily and conveniently.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

I claim:

1. A lampshade formed by a plurality of rings comprising an upper ring, a plurality of upper section unit rings, a middle ring, a plurality of lower section unit rings; and a lower ring, which are arranged sequentially from an upper end to an lower end; wherein
each upper section unit ring has a lower cross section; a plurality of hooked rings are extended from the lower cross section; one end of each hooked ring is a round hook and another end of the hooked ring is locked into the lower cross section of an adjacent upper section unit ring; the upper section unit rings are serially connected by using chains to pass through the hooked rings; two ends of the chain is locked to the upper ring and the middle ring;
each lower section unit ring has an upper cross section; a plurality of hooked rings are extended from the upper cross section; one end of each hooked ring is a round hook and another end of the hooked ring is locked into the lower cross section of an adjacent upper section unit ring; the lower section unit rings are serially connected by using chains to pass through the hooked rings; two ends of the chain is locked to the lower ring and the middle ring;
wherein by above structure, the lampshade is foldable so that the rings are overlapped and thus the whole lampshade has a smaller volume so that it can be stored and transferred easily and conveniently.

2. The lampshade formed by a plurality of rings as claimed in claim 1, wherein the lampshade has a maximum diameter at the middle ring, and diameters of the rings are reduced with the distances away from the middle ring.

3. The lampshade formed by a plurality of rings as claimed in claim 1, wherein the lampshade has a maximum diameter at the middle ring, and diameters of the rings are increased with the distances away from the middle ring.

4. The lampshade from by a plurality of rings as claimed in claim 1, wherein the lampshade has a maximum diameter at the upper ring, and diameters of the rings are reduced with the distances away from the upper ring.
